(19) United States
(12) Patent Application Publication
(10) Pub. No.: US 2024/0372658 A1
(43) Pub. Date: Nov. 7, 2024

(54) Methodology For Determining User Equipment Uplink Transmitted Resources And Information Technical Field

(71) Applicant: Nokia Technologies Oy, Espoo (FI)

(72) Inventors: Navin Hathiramani, Coppell, TX (US); Karri Markus Ranta-aho, Espoo (FI)

(21) Appl. No.: 18/142,630

(22) Filed: May 3, 2023

(51) Int. Cl. H04L 5/00; H04W 72/21

(52) U.S. Cl. CPC H04L 5/0035; H04L 5/0064; H04L 5/0098; H04W 72/21

(57) ABSTRACT

In accordance with example embodiments of the invention there is at least a method and apparatus to perform receiving or configuring a user equipment with a configuration for an uplink transmission on a plurality of carriers or cells, determining a subset of carriers or cells for uplink reception within the plurality of carriers or cells that scheduled the user equipment for uplink transmission, receiving or sending at least one uplink transmission with a communication network comprising an indication identifying the information transmitted in the selected subset of carriers or cells information for at least one uplink transmission by a user equipment comprising uplink transmission resources for two or more component carriers or cells for the at least one uplink transmission; and based on the information for determining component carriers or cells on which the user equipment transmitted, and identify the transmission for each component carrier where transmission resources where allocated.

The teachings in accordance with the exemplary embodiments of this invention relate to a new method where user equipment and base stations dynamically determines at least one uplink transmission carrier to coordinate uplink (UL) transmissions when a set of UL carriers is scheduled for user equipment UL transmission.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
ACK (positive) Acknowledgement
CA Carrier Aggregation
CG Configured Grant
CSI Channel State Information
CU Centralized Unit
DO Dual Connectivity
DCI Downlink Control Information
DL Downlink
DU Distributed Unit
FH Fronthaul
HARQ Hybrid Automatic Repeat request
HSDPA High Speed Downlink Packet Access
LTE Long Term Evolution (4G)
NACK Negative Acknowledgement
NR New Radio (5G)
NW Network
O-RAN Open RAN
PCell Primary Cell
PDCCH Physical Downlink Control Channel
PDSCH Physical Downlink Shared Channel
PHR Power Headroom Report
PUCCH Physical Uplink Control Channel
PUSCH Physical Uplink Shared Channel
RAN Radio Access Network
RU Radio Unit
SCell Secondary Cell
SPS Semi-Persistent Scheduling
SRB Signalling Radio Bearer
Tx Transmitter
UCI Uplink Control Information
UL Uplink
VoNR Voice over NR

Basic downlink carrier aggregation in 3G HSDPA, 4G LTE and 5G NR schedules data over two or more downlink carriers while the uplink feedback is routed over a single uplink carrier. This requires the processing unit responsible of the primary cell to know what to expect with regards to the secondary cell's feedback and route the secondary cell-relevant information to the processing unit responsible to of the secondary cell with low latency. Similarly, the secondary cell's processing unit must be able to receive the relevant feedback from the primary cell's processing unit without delays.

Example embodiments of the invention improve on at least these operations.

### SUMMARY

This section contains examples of possible implementations and is not meant to be limiting.

In another example aspect of the invention, there is an apparatus, such as a user equipment side apparatus, comprising: at least one processor; and at least one non-transitory memory storing instructions, that when executed by the at least one processor, cause the apparatus at least to: receive, by a user equipment of a communication network a configuration; determine based on the configuration the need for an uplink transmission of information on a subset of carriers or cells; and send at least one uplink transmission towards a network node of the communication network comprising an indication identifying the information transmitted in the selected subset of carriers or cells.

In still another example aspect of the invention, there is a method, comprising: receiving, by a user equipment of a communication network a configuration; determining based on the configuration the need for an uplink transmission of information on a subset of carriers or cells; and sending at least one uplink transmission towards a network node of the communication network comprising an indication identifying the information transmitted in the selected subset of carriers or cells.

A further example embodiment is an apparatus and a method comprising the apparatus and the method of the previous paragraphs, wherein the determining is based on at least one of a largest allocation, type of uplink allocation or a configured grant, based on a selected or preferred transmitter, associated with a switching time, a maximum permitted power per configured uplink, or additional maximum power reduction of a band, wherein the information comprises decoding information for a component carrier for the at least one uplink transmission, wherein the configuration comprises a power splitting configuration based on physical uplink control channel or physical uplink shared channel information to be simultaneously transmitted on uplink component carriers, wherein the configuration comprises a set of rules for prioritizing uplink transmissions in case of collisions between physical channels, wherein the prioritizing comprises prioritizing u-plane and c-plane data to be sent over the component carrier based on an available grant size and preconfigured rules, wherein the prioritizing comprises prioritizing c-plane date over u-plane data to be sent over the component carrier based on an available grant size and preconfigured rules, wherein u-plane refers to user-plane data that is data an end user is sending towards the targeted receiver (server, other end user for example), wherein c-plane refers to control plane data that terminates at a radio network or the end user equipment, such as using MAC headers or RRC messages, wherein the control plane data comprises at least one of a medium access control header, or a radio resource control message, wherein the decoding information comprises uplink control information comprising an uplink control information header indicating data included in each uplink transmission of the at least one uplink transmission, wherein the header comprises an N-UCI field, wherein the N-UCI field comprises a preconfigured identifier and a length field, wherein the N-UCI field is a fixed sized field, wherein the N-UCI field is present with a physical uplink shared channel for checking prior to physical uplink shared channel decoding, wherein the N-UCI field is present with a physical uplink control channel for checking prior to physical uplink shared channel decoding, wherein the N-UCI field is present as an extension to a MAC header when only data is transmitted over the at least one transmission, wherein the header is for determining uplink cells that transmitted data on different component carriers, and/or wherein the configuration is received by the user equipment from a network node of the communication network.

In another example aspect of the invention, there is an apparatus, such as a network side apparatus, comprising: at least one processor; and at least one non-transitory memory storing instructions, that when executed by the at least one processor, cause the apparatus at least to: configure, by a network node of a communication network, a user equipment with a configuration for an uplink transmission on a plurality of carriers or cells, determine a subset of carriers or cells for uplink reception within the plurality of carriers or cells that scheduled the user equipment for uplink transmission, receive information for at least one uplink transmission by a user equipment, wherein the information comprises uplink transmission resources for two or more component carriers or cells for the at least one uplink transmission; and based on the information, determine a subset of component carriers or cells on which the user equipment transmitted, and identify the transmission for each component carrier where transmission resources where allocated.

In still another example aspect of the invention, there is a method, comprising: configuring, by a network node of a communication network, a user equipment with a configuration for an uplink transmission on a plurality of carriers or cells, determining a subset of carriers or cells for uplink reception within the plurality of carriers or cells that scheduled the user equipment for uplink transmission; receiving information for at least one uplink transmission by a user equipment, wherein the information comprises uplink transmission resources for two or more component carriers or cells for the at least one uplink transmission; and based on the information, determining a subset of component carriers or cells on which the user equipment transmitted, and identify the transmission for each component carrier where transmission resources where allocated.

A further example embodiment is an apparatus and a method comprising the apparatus and the method of the previous paragraphs, wherein the information is based on at least one of a largest allocation, type of uplink allocation, a configured grant to the user equipment, based on a selected or preferred transmission, associated with a switching time, a maximum permitted power per configured uplink, or additional maximum power reduction of a band at the user equipment, wherein the information comprises decoding information for a component carrier for the at least one uplink transmission, wherein the configuration comprises a power splitting configuration based on physical uplink control channel or physical uplink shared channel information to be simultaneously transmitted on uplink component carriers, wherein the configuration comprises a set of rules for prioritizing uplink transmissions in case of collisions between physical channels, wherein the prioritizing comprises prioritizing u-plane or c-plane data to be sent over the component carrier based on an available grant size and preconfigured rules, wherein the prioritizing comprises prioritizing c-plane date over u-plane data to be sent over the component carrier based on an available grant size and preconfigured rules, wherein u-plane refers to user-plane data that is data an end user is sending towards the targeted receiver (server, other end user for example), wherein c-plane refers to control plane data that terminates at a radio network or the end user equipment, such as using MAC headers or RRC messages, wherein the control plane data comprises at least one of a medium access control header, or a radio resource control message, wherein the information is based on uplink control information comprising an uplink control information header indicating data included in each uplink transmission of the at least one uplink transmission, wherein the header comprises an N-UCI field, wherein the N-UCI field comprises a preconfigured identifier and a length field, wherein the N-UCI field is a fixed sized field, wherein the N-UCI field is present with a physical uplink shared channel for checking prior to physical uplink shared channel decoding, wherein the N-UCI field is present with a physical uplink control channel for checking prior to physical uplink shared channel decoding, wherein the N-UCI field is present as an extension to a MAC header when only data is transmitted over the at least one transmission, wherein the header is for determining uplink cells that transmitted data on different component carriers, wherein the identifying is using uplink-scheduling downlink control information sent to the user equipment and to a secondary network node of the communication network, wherein there is dynamically sharing with the secondary network node at least one of: a downlink control information grant or configured grant semi-persistent scheduling configuration, or user power headroom or estimated transmission power of the user equipment, wherein there is dynamically receiving from the secondary network node a provided at least one of: downlink control information grant or configured grant semi-persistent scheduling configuration, or user power headroom or estimated transmission power of the user equipment, wherein there is determining a probability of set of active uplinks; and determining whether an active uplink of the set belongs to the secondary network node, wherein there is based on there being an active uplink belonging to the secondary network node, demodulating at least one of a physical uplink control channel or a physical uplink shared channel; and decoding uplink control information from the secondary network node uplink front haul data, wherein there is determining if the decoding was successful, wherein there is, based on no active uplink belonging to the secondary network node, demodulating at least one of a physical uplink control channel or a physical uplink shared channel; and decoding uplink control information based on uplink front haul data based on shared uplink downlink control information or configured grant information, and/or wherein there is, based on uplink control information, indicating data for the secondary network node in included in the at least one of a physical uplink control channel or a physical uplink shared channel, discard other distributed unit data.

A communication system comprising the user equipment side apparatus and the network side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an example configuration for carrier aggregation (CA);

FIG. 2 shows an example of Centralized random-access network (RAN) architecture;

FIG. 3 shows a flow chart for a primary gNB;

FIG. 4 shows a flow chart for a secondary gNB

FIG. 5 shows a flow chart for a user equipment (UE);

FIG. 6 shows a high-level block diagram of various devices used in carrying out various aspects of the invention; and

FIG. 7A and FIG. 7B each show a method in accordance with example embodiments of the invention which may be performed by an apparatus.

### DETAILED DESCRIPTION

In example embodiments of this invention there is proposed at least a method and apparatus for a new method where user equipment and base stations dynamically determine at least one uplink transmission carrier to coordinate uplink (UL) transmissions when a set of UL carriers is scheduled for user equipment UL transmission.

As similarly stated above, basic downlink carrier aggregation in 3G HSDPA, 4G LTE and 5G NR schedules data over two or more downlink carriers while the uplink feedback is routed over a single uplink carrier. This requires the processing unit responsible of the primary cell to know what to expect with regards to the secondary cell's feedback and route the secondary cell-relevant information to the processing unit responsible to of the secondary cell with very low latency. Similarly, the secondary cell's processing unit must be able to receive the relevant feedback from the primary cell's processing unit without delays.

If also uplink (UL) carrier aggregation (CA) is supported, the location of the uplink control information in LTE and NR depends dynamically on what is being transmitted in the uplink:
UL CA or UL switching (two uplinks):
   PUSCH on primary only: UCI on primary;
   PUSCH on secondary only, UCI on secondary;
   PUSCH on both: UCI on primary:
      Power prioritization rules and Single UL operation (UL Tx Switching) add to the mix;
   PUCCH on primary (only happens if no PUSCH in uplink: UCI on primary

The fact that sometimes the UCI is on primary UL, sometimes on the secondary UL causes further complications in managing the uplink control information in non-monolithic base stations architectures.

Conversely in Dual Connectivity, where the base assumption is that two non-collocated base stations are in connection with the same UE the feedback problem is solved by the UE having a dedicated uplink connection with each base station. The problem with this is that the UE needs to support transmission of two uplinks simultaneously, and it also requires the Tx power to be split between the two uplinks reducing the coverage that each uplink can support. In some cases, the UE may be restricted from operating two uplinks simultaneously to avoid intermodulation issues.

In all the above scenarios in which multiple ULs are involved there is a better need to coordinate UL transmissions. In NR, EN-DC use cases based on Simultaneous UL transmissions on both LTE and NR did not adopt any power sharing rules, but relied on hard power split between the LTE and NR uplinks, the dynamic power control interaction was difficult to implement within the chipset of 4G and 5G. Chipset vendors did not want to deal with this complexity, requesting network vendors to take the implementation burden.

Furthermore, for NR capacity expansion in scenarios where DUs are not collocated, inter-site CA (two sites transmitting downlink, only one receiving uplink) may be preferred over NR DC. Inter-site CA has also been implemented for LTE, but adoption is low due to inherent delays in forwarding data from PCell to SCell, which in some deployments may prevent CA (or CA-like) operation relying on one uplink providing the uplink feedback for all the downlinks.

However, there is a problem of how to support carrier aggregation with non-monolithic base station architectures without requiring two uplinks and avoid the latencies incurred by the need to route control information between the processing units.

Proprietary interface between processing units (DUs, gNBs, base stations, cell sites) to route the UCI received by one processing unit to the other processing unit incurs latency, which in some deployments may prevent CA (or CA-like) operation relying on one uplink providing the uplink feedback for all the downlinks.

Prior art here is based on a reactive approach of forwarding the UCI data for SCell after it has been received by the PCell.

This incurs into latency penalties which impact over all end to end throughput performance or may make the support for CA (or CA-like) operation infeasible. The solution proposed here, takes a proactive or an initiating taking approach to inform the SCell of when and where the UCI and/or UL data may be sent.

As discussed below an O-RAN terminology is used, but the concepts should be understood more broadly with RU referring to a radio unit connected to the DU that is the BB processing unit.

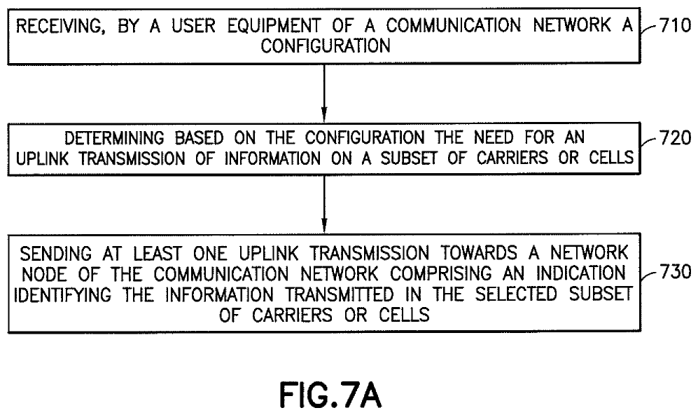

Before describing the example embodiments as disclosed herein in detail, reference is made to FIG. 6 for illustrating a simplified block diagram of various electronic devices that are suitable for use in practicing the example embodiments of this invention.

FIG. 6 shows a block diagram of one possible and non-limiting exemplary system in which the example embodiments may be practiced. In FIG. 6, a user equipment (UE) 10 is in wireless communication with a wireless network 1 or network, 1 as in FIG. 6. The wireless network 1 or network 1 as in FIG. 6 can comprise a communication network such as a mobile network e.g., the mobile network 1 or first mobile network as disclosed herein. Any reference herein to a wireless network 1 as in FIG. 6 can be seen as a reference to any wireless network as disclosed herein. Further, the wireless network 1 as in FIG. 6 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 6. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 6. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 6 can be used for communication with the NN12. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 6.

The one or more buses of the device of FIG. 6 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to an RRH.

It is noted that although FIG. 6 shows a network node such as NN 12 and NN 13, any of these nodes may can incorporate or be incorporated into an eNodeB or eNB or gNB such as for LTE and NR, and would still be configurable to perform example embodiments.

Also, it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR. 5G and/or any standards-based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g., based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 6, as at least described below, can be co-located with UE 10 such as to be separate from the NN 12 and/or NN 13 of FIG. 6 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and such virtualized entities create technical effects.

The computer readable memories MEM 12B, MEM 13B, and MEM 14B may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general-purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High-Altitude Platform Station, or any other such type node associated with a terrestrial network or any drone type radio or a radio in aircraft or other airborne vehicle or a vessel that travels on water such as a boat.

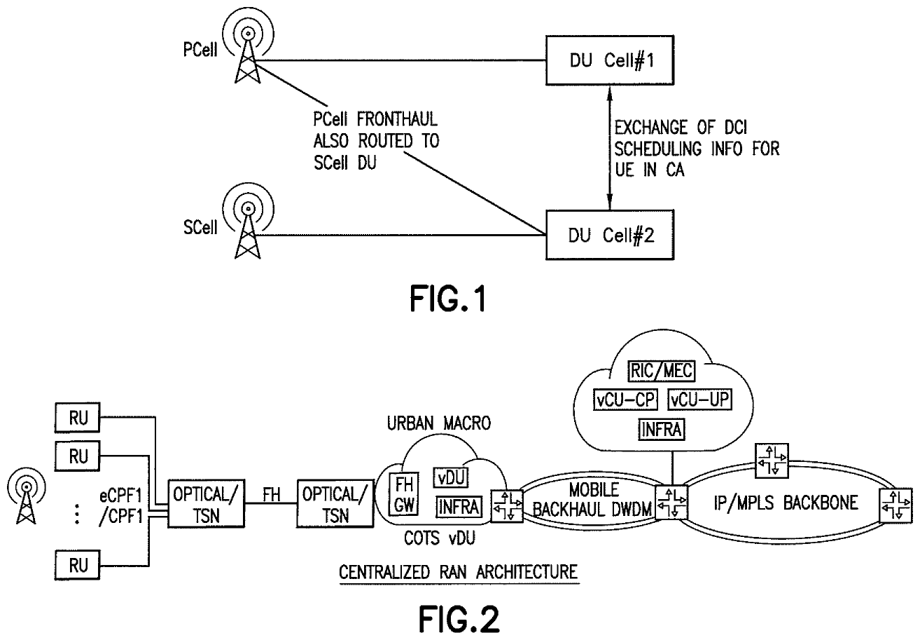

FIG. 1 shows an example configuration for carrier aggregation (CA).

As shown in FIG. 1, in accordance with example embodiments of the invention the UE's uplink is received in a radio unit (RU) and routed to two processing units, distributed units (DU) (see FIG. 1).

When scheduling the UE in the downlink the DU forwards its downlink-scheduling Downlink Control Information (DCI) scheduling message sent to the UE also to the other DU. There is natural latency tolerance here as it takes time for the UE to receive the corresponding PDSCH and start transmitting the HARQ-ACK. Similarly, when scheduling the UE to transmit in the uplink, the uplink-scheduling DCI is sent by the scheduling DU to the other DU, there is a minimum delay from the UE's reception of the DCI before it is able to start transmitting the corresponding PUSCH. The interface employed for these exchanges could be a high speed interface for inter-vendor CA, as well as for 5G-6G Dynamic Spectrum Sharing in 3GPP.

Each DU will demodulate the same uplink and extract the uplink control information (UCI) consisting of HARQ-ACK and/or CSI reports from the uplink transmission, (PUCCH or PUSCH) when needed.

If the configuration is such that separate uplinks are configured, the decision rules on whether to transmit both, or only one (and which one) uplink come in effect and the UE dynamically determines its uplink transmission carrier(s) based on the decision rules. Due to the knowledge of each other's DCIs the two DUs can track the dynamics and know which uplink to expect the PUSCH and/or UCI to be on, and what type of UCI to expect on that uplink.

The UE determination in this case can for example be based on the largest UL grant (DCI or configured grant) received or based on currently selected transmitter and associated switching time or max permitted power per configured UL and AMPR of the band. Regardless of how the UE performs the determination, the UE can have freedom to select the UL(s) and the DUs expecting the UL information will at most have to perform N hypothesis on where the UL is transmitted, with N being the number of ULs the UE is configured with. The value of N can be reduced with some policy/rules from the network to the UE.

When the UE selects only one UL for transmission when it requires to transmit UL data/control information for more than one UL, it may include a new control information field (denoted N-UCI) within the UL transmission to indicate how each cell should perform the decoding of the UL information transmitted. This N-UCI field could be as a simple as one field indicating the intended UL cell based on a preconfigured identifier and another field with the length in bits/bytes of the payload for this cell.

N-UCI can be fixed-sized field that is at least one of:
always-present with PUSCH and in a similar fashion as UCI-on-PUSCH so that this field can be checked before proceeding with PUSCH decoding;
an extension to the MAC-header (when used only to determine what data is transmitted on PUSCH); and/or
if needed, an extension field to UCI on PUCCH.

This information is used to determine to which uplink cells the data received on the transmitted carrier was originally supposed to be transmitted on. This would not be unambiguously known from the DCIs at the network end, because the UE would map the uplink data from its buffers to the scheduled carriers in priority order, but the network does not know in advance which bearers' data ends up on a transmitted PUSCH. This of course also adds robustness against missed DCI errors. Via this N-UCI field the UE has the possibility to for example choose the largest UL grant of the two received for transmission in the same slot and then prioritize the information for which the discarded grant was intended to e.g. prioritize the VoNR or SRB data which may be only be configured for the PCell with no CA or DC.

Note that regular UCI on PUCCH may be deterministically known by base stations e.g., what HARQ-ACKs and/or what CSIs there are supposed to be. Further, the UE's priority transmission rules could kick in when data is transmitted, though N-UCI may not be needed when there is no data, which may be the case when only PUCCH is sent.

Note this solution is applicable to LTE, 5G and 6G. For LTE the framework could be limited to working with the existing UE base with no advancements in the uplink selection and no introduction of the N-UCI.

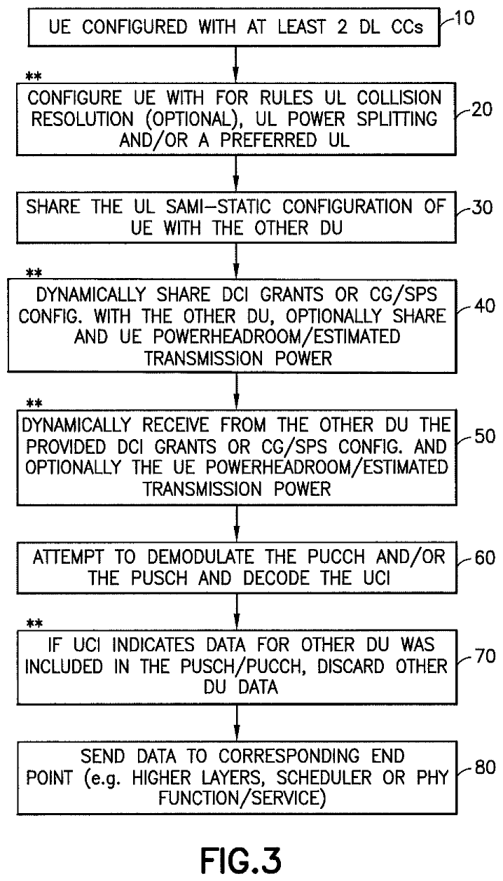

FIG. 2 shows an example of Centralized random-access network (RAN) architecture.

For example, a centralized RAN (C-RAN) architecture as depicted in FIG. 2. could be mainly targeted to Urban areas where capacity expansion is typically required. As stated above the solution requires that an RU that receives the UL is routed to more than one DU.

It can be observed how a number of RUs are deployed remotely and then employ a transport network to access a centralized location where all the DU processing is done. In these deployments the transport at the C-RAN location is typically handled by a Fronthaul Gateway (FH GW) which then routes the different incoming/outgoing streams to the desired location. Thus, enabling the above requirement could be a simple configuration change to forward incoming UL data from one RU to more than one endpoint.

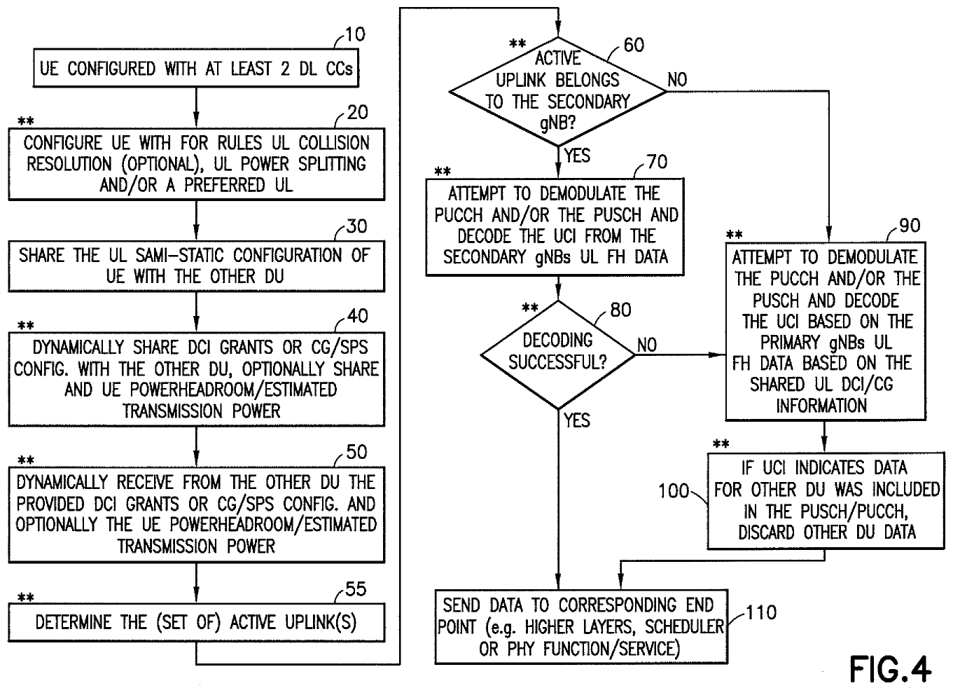

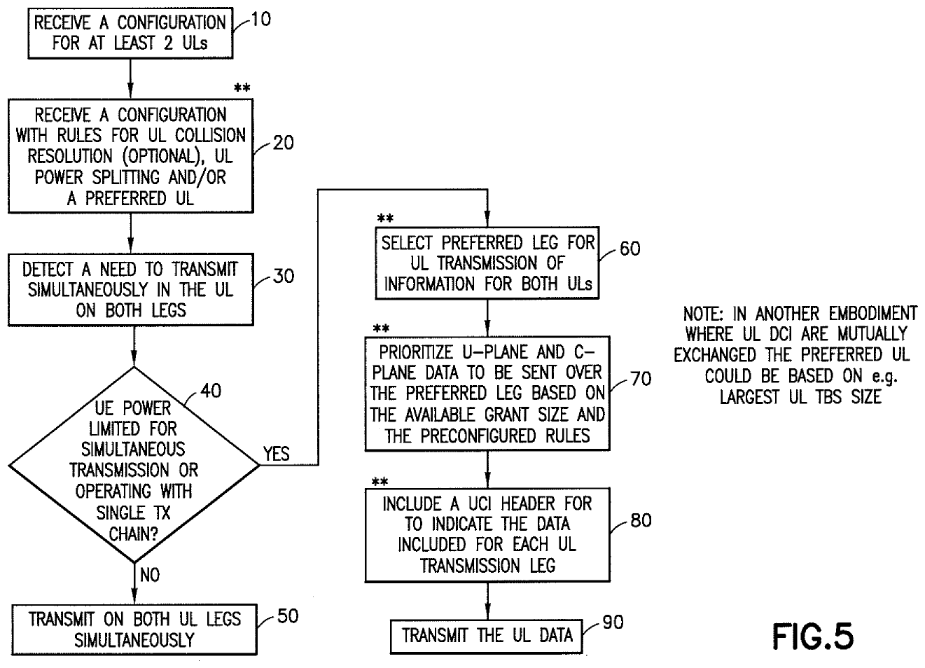

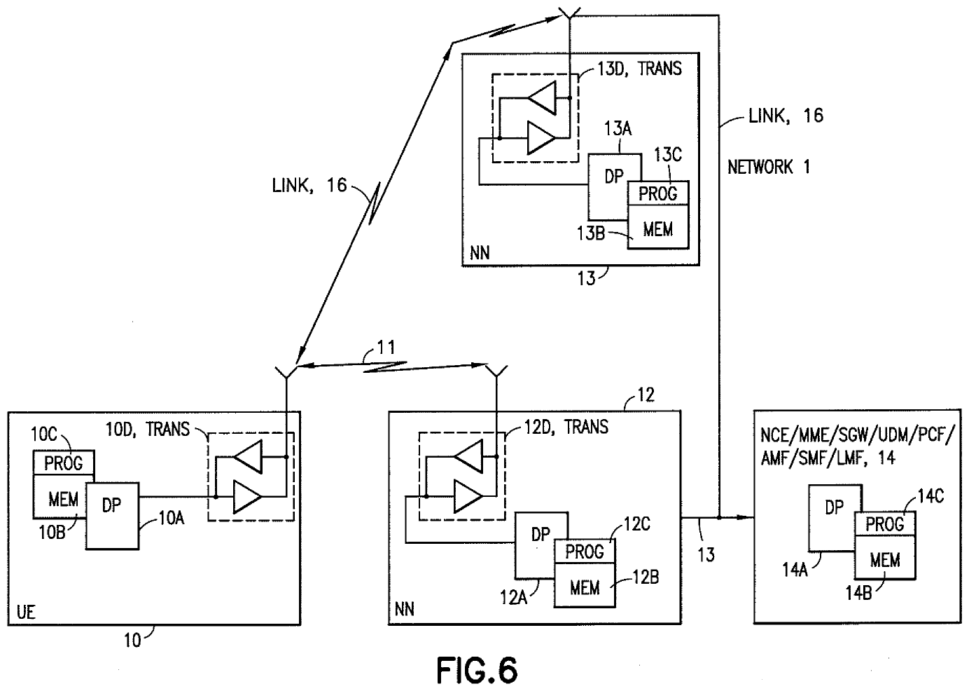

Flow charts for the primary gNB, secondary gNB and UE are depicted in FIG. 2, FIG. 3, FIG. 4, and FIG. 5 where the novel steps are noted with double asterisks**.

The primary gNB is denominated as such since this the gNB where UE could default all UL transmissions to if there is e.g., a need for simultaneous UL transmissions which are not possible (see FIG. 5).

FIG. 3 shows a flow chart for a primary gNB.

As shown in step 10 of FIG. 3 a UE is configured with at least 2 DL Component Carriers and in addition may receive a configuration to help in the determination of how to transmit UL information when more than one UL is configured as shown in step 20 of FIG. 3.

As shown in double asterisks step 20 of FIG. 3 in accordance with example embodiments of the invention there is configuring the UE by the gNB with rules for optional uplink collision resolution, uplink power splitting, and/or a preferred uplink.

As shown in step 30 of FIG. 3 there is sharing the UL semi-static configuration of the UE with another or the other DUs.

This configuration can provide the UE a set of rules such as a preferred UL for transmission any time there is a need for simultaneous UL transmission or how to perform power splitting depending on the PUCCH/PUSCH information to be transmitted on each UL leg. These set of rules could also include some policy on how to prioritize UL transmissions in case of collisions between PUSCH and RACH e.g. In [30] the DUs involved in the CA configuration share the information on semi-static UL configuration of the UE, such as RACH, periodic PUCCH occasions, PUCCH configurations, etc.

As shown in double asterisks step 40 of FIG. 3 in accordance with example embodiments of the invention there is dynamically sharing downlink control information grants of CG/SPS configuration with other distributed units and/or optionally sharing user equipment power headroom and/or estimated transmission power.

As shown in double asterisks step 50 of FIG. 3 in accordance with example embodiments of the invention there is dynamically receiving from another or a secondary distributed unit provided downlink control information (DCI) grants or CG/SPS configuration, and optionally user equipment power headroom and/or estimated transmission power.

As shown in step 60 of FIG. 3 there is attempting to demodulate the PUCCH and/or the PUSCH and decode the UCI.

In [steps 40 and/or 50] The DUs involved in the CA configuration dynamically share DCI or configured grant or semi-persistent information for the UEs configured with CA. The DUs could additionally share information on UE PHR or estimate transmission power. In [60] the primary gNB attempts to demodulate the PUCCH and or the PUSCH and decode the new N-UCI field. If it encounters the new N-UCI field(s) indicating a multiplexing of information from different UL legs, it discards data of the other UL legs [70].

As shown in double asterisks step 70 of FIG. 3 in accordance with example embodiments of the invention there is determining if the uplink control information indicates data for another or a secondary distributed unit was included in PUSCH or PUCCH, there is discarding the another or a secondary distributed unit data.

As shown in step 80 of FIG. 3 there is sending data to corresponding end point (e.g., higher layer, schedulers, or PHY function/service).

In step [80] of FIG. 3 the gNB proceeds to normal operations and forwards the received data to its intended recipients.

FIG. 4 depicts the flowchart for the secondary gNB. It is also possible to have all DUs within the CA configuration to be configured as secondary gNB if there is no single preferred UL for transmission when UE can't transmit on more than one. The initial steps of a gNB operating in this mode are similar to those of a primary gNB [10-50].

First, it is noted that the steps 10, 20, 30, 40, and 50 of FIG. 4 are the same as in FIG. 3.

As shown in double asterisks step 55 of FIG. 4 in accordance with example embodiments of the invention there is shown additional steps 55, 60, 70, 80, 90, and 100.

In accordance with example embodiments of the invention as shown in FIG. 4 the difference between FIG. 3 and FIG. 4 comes in at step [55] of FIG. 4, where the gNB has to determine all possible ULs where the UE could transmit.

If at step 55 of FIG. 4 the gNB determines that there is a high probability that the UE will select its configured UL for the UL transmission [70], a set of active uplinks will be determined, and it will proceed to attempt to decode the UL received from its RU via the FH.

As shown in double asterisks step 55 of FIG. 4 in accordance with example embodiments of the invention there is determining an active uplink or a set of active uplinks.

Here, the determination of the probability of each UL within the active UL set could be based for example on the PHR information exchanged and the expected UL transmission in a given slot. With this information the gNB could predict whether the UE would be able to employ simultaneous UL e.g., Note this is only a prediction because radio conditions can vary and hence UL power requirements for each leg will also vary accordingly and the gNBs PHR could also be somewhat outdated.

As shown in double asterisks step 60 of FIG. 4 in accordance with example embodiments of the invention there is determining whether an active uplink belongs to another or a secondary gNB or base station.

As shown in double asterisks step 70 of FIG. 4 in accordance with example embodiments of the invention there is based on determining active uplink(s) and attempting to demodulate the PUCCH and/or the PUSCH and decoding UCI from the secondary base station uplink FH data.

As shown in double asterisks step 80 of FIG. 4 in accordance with example embodiments of the invention there is determining whether the decoding is successful.

If the decoding fails [e.g., in double asterisks step 80 of FIG. 4], then in accordance with example embodiments of the invention the gNB would attempt to decode the UL from the fronthaul data received from another cell configured for the UL within the CA configuration [double asterisks step 90 of FIG. 4].

As shown in double asterisks step 90 of FIG. 4 in accordance with example embodiments of the invention there is for a case the decoding as in step 80 of FIG. 4 is not successful then as shown in step 90 of FIG. 4 there is attempting to demodulate the PUCCH and/or PUSCH and decoding the UCI based on the primary base station uplink FH data based on shared UL DCI/CG information.

Then as shown in double asterisks step 100 of FIG. 4 in accordance with example embodiments of the invention there is if the UCI indicates data for other DU was included in the PUCCH and/or PUSCH then discard the other DU data.

In this scenario, since the DCIs and other UL scheduling information are exchanged dynamically, the secondary gNB knows exactly where the UL information is located if it was transmitted via the chosen UL. Once the UL is decided the gNB employs the new N-UCI field to select its corresponding data and discards the rest [as shown in step 100].

As shown in step 110 of FIG. 4 there is sending data to a corresponding end point (e.g., higher layers, scheduler, or PHY (function/service).

FIG. 5 depicts the flowchart for the user equipment.

From a UE point of view (FIG. 5), in step [10] of FIG. 5 UE is configured with at least two ULs.

As shown in step 10 of FIG. 5 there is receiving a configuration for at least 2 uplinks (ULs).

As shown in double asterisks step 20 of FIG. 5 in accordance with example embodiments of the invention there is receiving a configuration with rules for optional uplink collision resolution, uplink power splitting, and/or a preferred UL.

The UE may receive a set of rules with information as in step [20] of FIG. 5 on how to perform power splitting (if it supports simultaneous transmission) based on what it needs to transmit on each UL leg, determine a preferred UL in case It can't perform simultaneous transmission. These set of rules could also include some policy on how to prioritize UL transmissions in case of collisions between PUSCH and RACH e.g.

In step 30 of FIG. 5, the UE detects a need to transmit simultaneously on more than one UL leg.

In step 40 of FIG. 5 the UE determines whether it will perform UL transmission on more than one UL leg or it will only transmit on a single UL. This determination can be based on prior art procedure of available power per leg, the UE capability to perform simultaneous transmission etc. If the UE decides it does have the capability to transmit on both legs it proceeds as per the current state of art as shown in step 50 of FIG. 5.

As shown in double asterisks step 60 of FIG. 5 in accordance with example embodiments of the invention there is based on power limited for simultaneous transmission or operating with a single transmission chain, there is as shown in step 60 selecting a preferred leg for uplink transmission of information for both ULs.

If the UE determines that it does not have the capability to transmit on both UL legs, then in step 60 of FIG. 5 the UE determines a preferred leg for UL transmission. If the UE is configured for more than 2 ULs, than in this step the UE would determine its preferred legs for transmission that are within its capabilities. The selection of this preferred leg could be based just on configuration from gNB (e.g., step 20 of FIG. 5) or it can be based on e.g., the size of the available grants or the currently configured UL and transition time to switch UL.

As shown in double asterisks step 70 of FIG. 5 in accordance with example embodiments of the invention there is prioritizing U-plane and C-plane data to be sent over the preferred leg based on available grant size and the preconfigured rules. It is noted that u-plane refers to user-plane data that is data an end user is sending towards the targeted receiver (server, other end user for example), wherein c-plane refers to control plane data that terminates at a radio network or the end user equipment, such as using MAC headers or RRC messages.

The control plane is the part of a network that controls how data packets are forwarded—meaning how data is sent from one place to another. The process of creating a routing table, for example, is considered part of the control plane. Routers use various protocols to identify network paths, and they store these paths in routing tables.

Some examples of control planes include routing protocols (like BGP, OSPF, and IS-IS), network management protocols (SNMP), and application layer protocols (think HTTP and FTP).

A data plane that carries user traffic (sometimes known as the user plane, forwarding plane, carrier plane or bearer plane), the control plane, and the management plane are the three basic components of a telecommunications architecture.

Then as shown in double asterisks step 80 of FIG. 5 in accordance with example embodiments of the invention there is including a UCI header to indicate data included for each transmission leg.

In steps 70-80 once the preferred UL is selected, the UE prioritizes the data the to be sent within the chosen grant and includes new N-UCI field to facilitate the decoding at the different UL cells.

As shown in step 90 of FIG. 5 there is transmitting the uplink data.

Further, it is noted in FIG. 5 that in another example embodiments of the invention where UL DCIs is mutually exchanged, the predetermined UL could be based on for example a largest UL TBS size.

Note for a UE configured with a single UL, there would be no major impact on the UE side.

Note that although the descriptions above can be based on a CA scenario, the same exact logic is applicable for DC deployments.

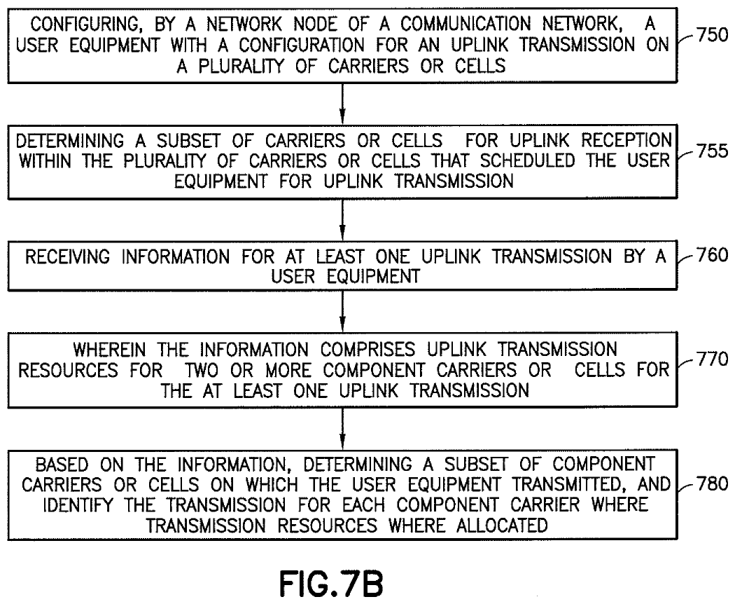

FIG. 7A and FIG. 7B each show a method in accordance with example embodiments of the invention which may be performed by an apparatus.

FIG. 7A illustrates operations which may be performed by a network device such as, but not limited to, a user terminal or user equipment such as the UE 10 as in FIG. 6. As shown in step 710 of FIG. 7A there is receiving, by a user equipment of a communication network a configuration. As shown in step 720 of FIG. 7A there is determining based on the configuration the need for an uplink transmission of information on a subset of carriers or cells. Then as shown in step 730 of FIG. 7A there is sending at least one uplink transmission towards a network node of the communication network comprising an indication identifying the information transmitted in the selected subset of carriers or cells.

In accordance with the example embodiments as described in the paragraph above, wherein the determining is based on at least one of a largest allocation, type of uplink allocation or a configured grant, based on a selected or preferred transmitter, associated with a switching time, a maximum permitted power per configured uplink, or additional maximum power reduction of a band.

In accordance with the example embodiments as described in the paragraphs above, wherein the information comprises decoding information for a component carrier for the at least one uplink transmission.

In accordance with the example embodiments as described in the paragraphs above, wherein the configuration comprises a power splitting configuration based on physical uplink control channel or physical uplink shared channel information to be simultaneously transmitted on uplink component carriers.

In accordance with the example embodiments as described in the paragraphs above, wherein the configuration comprises a set of rules for prioritizing uplink transmissions in case of collisions between physical channels.

In accordance with the example embodiments as described in the paragraphs above, wherein the prioritizing comprises prioritizing u-plane or c-plane data to be sent over the component carrier based on an available grant size and preconfigured rules.

In accordance with the example embodiments as described in the paragraphs above, wherein the prioritizing comprises prioritizing c-plane date over u-plane data to be sent over the component carrier based on an available grant size and preconfigured rules.

In accordance with the example embodiments as described in the paragraphs above, wherein u-plane refers to user-plane data that is data an end user is sending towards the targeted receiver (server, other end user for example), wherein c-plane refers to control plane data that terminates at a radio network or the end user equipment, such as using MAC headers or RRC messages.

In accordance with the example embodiments as described in the paragraphs above, wherein the control plane data comprises at least one of a medium access control header, or a radio resource control message.

In accordance with the example embodiments as described in the paragraphs above, wherein the decoding information comprises uplink control information comprising an uplink control information header indicating data included in each uplink transmission of the at least one uplink transmission.

In accordance with the example embodiments as described in the paragraphs above, wherein the header comprises an N-UCI field.

In accordance with the example embodiments as described in the paragraphs above, wherein the N-UCI field comprises a preconfigured identifier and a length field.

In accordance with the example embodiments as described in the paragraphs above, wherein the N-UCI field is a fixed sized field.

In accordance with the example embodiments as described in the paragraphs above, wherein the N-UCI field is present with a physical uplink shared channel for checking prior to physical uplink shared channel decoding.

In accordance with the example embodiments as described in the paragraphs above, wherein the N-UCI field is present with a physical uplink control channel for checking prior to physical uplink shared channel decoding.

In accordance with the example embodiments as described in the paragraphs above, wherein the N-UCI field is present as an extension to a MAC header when only data is transmitted over the at least one transmission.

In accordance with the example embodiments as described in the paragraphs above, wherein the header is for determining uplink cells that transmitted data on different component carriers.

In accordance with the example embodiments as described in the paragraphs above, wherein the configuration is received by the user equipment from a network node of the communication network.

A non-transitory computer-readable medium (MEM 10B as in FIG. 6) storing program code (PROG 10C as in FIG. 6), the program code executed by at least one processor (DP 10A as in FIG. 6) to perform the operations as at least described in the paragraphs above.

In accordance with an example embodiment of the present disclosure as described above there is an apparatus comprising: means for receiving (one or more transceivers 10D; MEM 10B; PROG 10C; and DP 10A as in FIG. 6), by a user equipment (UE 10 as in FIG. 6) of a communication network a configuration; means for determining (one or more transceivers 10D; MEM 10B; PROG 10C; and DP 10A as in FIG. 6) based on the configuration the need for an uplink transmission of information on a subset of carriers or cells; and means for sending (one or more transceivers 10D; MEM 10B; PROG 10C; and DP 10A as in FIG. 6) at least one uplink transmission towards a network node of the communication network comprising an indication identifying the information transmitted in the selected subset of carriers or cells.

In the example aspect of the present disclosure according to the paragraph above, wherein at least the means for receiving, determining, and sending comprises a non-transitory computer readable medium [MEM 10B as in FIG. 6] encoded with a computer program [PROG 10C as in FIG. 6] executable by at least one processor [DP 10A as in FIG. 6].

FIG. 4B illustrates operations which may be performed by a network node such as, but not limited to, a gNB or eNB, or the NN 12 or NN 13 as in FIG. 6. As shown in step 750 of FIG. 7B there is configuring, by a network node of a communication network, a user equipment with a configuration for an uplink transmission on a plurality of carriers or cells. As shown in step 755 of FIG. 7B there is determining a subset of carriers or cells for uplink reception within the plurality of carriers or cells that scheduled the user equipment for uplink transmission. As shown in step 760 of FIG. 7B there is receiving information for at least one uplink transmission by a user equipment. As shown in step 770 of FIG. 7B, wherein the information comprises uplink transmission resources for two or more component carriers or cells for the at least one uplink transmission. Then as shown in step 780 of FIG. 7B there is, based on the information, determining a subset of component carriers or cells on which the user equipment transmitted, and identify the transmission for each component carrier where transmission resources where allocated.

In accordance with the example embodiments as described in the paragraph above, wherein the information is based on at least one of a largest allocation, type of uplink allocation, a configured grant to the user equipment, based on a selected or preferred transmission, associated with a switching time, a maximum permitted power per configured uplink, or additional maximum power reduction of a band at the user equipment.

In accordance with the example embodiments as described in the paragraphs above, wherein the information comprises decoding information for a component carrier for the at least one uplink transmission.

In accordance with the example embodiments as described in the paragraphs above, wherein the configuration comprises a power splitting configuration based on physical uplink control channel or physical uplink shared channel information to be simultaneously transmitted on uplink component carriers.

In accordance with the example embodiments as described in the paragraphs above, wherein the configuration comprises a set of rules for prioritizing uplink transmissions in case of collisions between physical channels.

In accordance with the example embodiments as described in the paragraphs above, wherein the prioritizing comprises prioritizing u-plane or c-plane data to be sent over the component carrier based on an available grant size and preconfigured rules.

In accordance with the example embodiments as described in the paragraphs above, wherein the prioritizing comprises prioritizing c-plane date over u-plane data to be sent over the component carrier based on an available grant size and preconfigured rules.

In accordance with the example embodiments as described in the paragraphs above, wherein u-plane refers to user-plane data that is data an end user is sending towards the targeted receiver (server, other end user for example), wherein c-plane refers to control plane data that terminates at a radio network or the end user equipment, such as using MAC headers or RRC messages.

In accordance with the example embodiments as described in the paragraphs above, wherein the control plane data comprises at least one of a medium access control header, or a radio resource control message.

In accordance with the example embodiments as described in the paragraphs above, wherein the information is based on uplink control information comprising an uplink control information header indicating data included in each uplink transmission of the at least one uplink transmission.

In accordance with the example embodiments as described in the paragraphs above, wherein the header comprises an N-UCI field.

In accordance with the example embodiments as described in the paragraphs above, wherein the N-UCI field comprises a preconfigured identifier and a length field.

In accordance with the example embodiments as described in the paragraphs above, wherein the N-UCI field is a fixed sized field.

In accordance with the example embodiments as described in the paragraphs above, wherein the N-UCI field is present with a physical uplink shared channel for checking prior to physical uplink shared channel decoding.

In accordance with the example embodiments as described in the paragraphs above, wherein the N-UCI field is present with a physical uplink control channel for checking prior to physical uplink shared channel decoding.

In accordance with the example embodiments as described in the paragraphs above, wherein the N-UCI field is present as an extension to a MAC header when only data is transmitted over the at least one transmission.

In accordance with the example embodiments as described in the paragraphs above, wherein the header is for determining uplink cells that transmitted data on different component carriers.

In accordance with the example embodiments as described in the paragraphs above, wherein the identifying is using uplink-scheduling downlink control information sent to the user equipment and to a secondary network node of the communication network.

In accordance with the example embodiments as described in the paragraphs above, wherein there is dynamically sharing with the secondary network node at least one of: a downlink control information grant or configured grant semi-persistent scheduling configuration, or user power headroom or estimated transmission power of the user equipment.

In accordance with the example embodiments as described in the paragraphs above, wherein there is dynamically receiving from the secondary network node a provided at least one of: downlink control information grant or configured grant semi-persistent scheduling configuration, or user power headroom or estimated transmission power of the user equipment.

In accordance with the example embodiments as described in the paragraphs above, wherein there is determining a probability of set of active uplinks; and determining whether an active uplink of the set belongs to the secondary network node.

In accordance with the example embodiments as described in the paragraphs above, wherein there is based on there being an active uplink belonging to the secondary network node, demodulating at least one of a physical uplink control channel or a physical uplink shared channel; and decoding uplink control information from the secondary network node uplink front haul data.

In accordance with the example embodiments as described in the paragraphs above, wherein there is determining if the decoding was successful.

In accordance with the example embodiments as described in the paragraphs above, wherein there is, based on no active uplink belonging to the secondary network node, demodulating at least one of a physical uplink control channel or a physical uplink shared channel; and decoding uplink control information based on uplink front haul data based on shared uplink downlink control information or configured grant information.

In accordance with the example embodiments as described in the paragraphs above, wherein there is, based on uplink control information, indicating data for the secondary network node is included in the at least one of a physical uplink control channel or a physical uplink shared channel, discard other distributed unit data.

A non-transitory computer-readable medium (MEM 12B and/or MEM 13B as in FIG. 6) storing program code (PROG 12C and/or PROG 13C as in FIG. 6), the program code executed by at least one processor (DP 12A and/or DP 13A as in FIG. 6) to perform the operations as at least described in the paragraphs above.

In accordance with an example embodiment of the present disclosure as described above there is an apparatus comprising: means for configuring (one or more transceivers 12D and/or 13D; MEM 12B and/or MEM 13B; PROG 12C and/or PROG 13C; and DP 12A and/or DP 13A as in FIG. 6), by a network node (NN 12 and/or NN 13 as in FIG. 6) of a communication network (Network 1 as in FIG. 6), a user equipment with a configuration for an uplink transmission on a plurality of carriers or cells, means for determining (one or more transceivers 12D and/or 13D; MEM 12B and/or MEM 13B; PROG 12C and/or PROG 13C; and DP 12A and/or DP 13A as in FIG. 6), by a network node (NN 12 and/or NN 13 as in FIG. 6) a subset of carriers or cells for uplink reception within the plurality of carriers or cells that scheduled the user equipment for uplink transmission; means for receiving (one or more transceivers 12D and/or 13D; MEM 12B and/or MEM 13B; PROG 12C and/or PROG 13C; and DP 12A and/or DP 13A as in FIG. 6) information for at least one uplink transmission by a user equipment, wherein the information comprises uplink transmission resources for two or more component carriers or cells for the at least one uplink transmission; and means, based on the information, for determining (one or more transceivers 12D and/or 13D; MEM 12B and/or MEM 13B; PROG 12C and/or PROG 13C; and DP 12A and/or DP 13A as in FIG. 6) a subset of component carriers or cells on which the user equipment transmitted, and identify the transmission for each component carrier where transmission resources where allocated.

In the example aspect of the present disclosure according to the paragraph above, wherein at least the means for configuring, receiving, and determining comprises a non-transitory computer readable medium [MEM 12B and/or MEM 13B as in FIG. 6] encoded with a computer program [PROG 12C and/or PROG 13C as in FIG. 6] executable by at least one processor [DP 12A and/or DP 13A as in FIG. 6].

Advantages in accordance with example embodiments of the invention include:
Enabling Inter site CA with better performance than prior art solutions;
Minimal impact to existing deployments, mostly just a configuration change;
Moving complexity away from the UE and is not extremely complex to implement form NW side; and
Single framework supporting UE with diverse UL capabilities (Single UL, simultaneous UL, dynamic power sharing, etc.)

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic, or any combination thereof. For example, some aspects may be implemented in hardware, while other aspects may be implemented in firmware or software which may be executed by a controller, microprocessor, or other computing device, although the invention is not limited thereto. While various aspects of the invention may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. An apparatus, comprising:
at least one processor; and
at least one non-transitory memory storing instructions, that when executed by the at least one processor, cause the apparatus at least to:
receive, by a user equipment of a communication network a configuration;
determine based on the configuration the need for an uplink transmission of information on a subset of carriers or cells; and
send at least one uplink transmission towards a network node of the communication network comprising an indication identifying the information transmitted in the selected subset of carriers or cells.

2. The apparatus of claim 1, wherein the determining is based on at least one of a largest allocation, type of uplink allocation or a configured grant, based on a selected or preferred transmitter, associated with a switching time, a maximum permitted power per configured uplink, or additional maximum power reduction of a band.

3. The apparatus of claim 1, wherein the information comprises decoding information for a component carrier for the at least one uplink transmission.

4. The apparatus of claim 3, wherein the configuration comprises a power splitting configuration based on physical uplink control channel or physical uplink shared channel information to be simultaneously transmitted on uplink component carriers.

5. The apparatus of claim 3, wherein the configuration comprises a set of rule for prioritizing uplink transmissions in case of collisions between physical channels.

6. The apparatus of claim 5, wherein the prioritizing comprises prioritizing u-plane or c-plane data to be sent over the component carrier based on an available grant size and preconfigured rules.

7. The apparatus of claim 6, wherein u-plane refers to user-plane data that is data an end user is sending towards the targeted receiver comprising at least one of a server or other end user, and wherein c-plane refers to control plane data that terminates at a radio network or the end user equipment, wherein the control plane data comprises at least one of a medium access control header, or a radio resource control message.

8. The apparatus of claim 3, wherein the decoding information comprises uplink control information comprising an uplink control information header indicating data included in each uplink transmission of the at least one uplink transmission.

9. The apparatus of claim 8, wherein the header comprises an N-UCI field.

10. The apparatus of claim 9, wherein the N-UCI field comprises a preconfigured identifier and a length field.

11. The apparatus of claim 9, wherein the N-UCI field is a fixed sized field.

12. The apparatus of claim 9, wherein the N-UCI field is present with a physical uplink shared channel for checking prior to physical uplink shared channel decoding.

13. The apparatus of claim 8, wherein the N-UCI field is present with a physical uplink control channel for checking prior to physical uplink shared channel decoding.

14. The apparatus of claim 9, wherein the N-UCI field is present as an extension to a MAC header when only data is transmitted over the at least one transmission.

15. The apparatus of claim 8, wherein the header is for determining uplink cells that transmitted data on different component carriers.

16. The apparatus of claim 1, wherein the configuration is received by the user equipment from a network node of the communication network.

17. A method, comprising:
receiving, by a user equipment of a communication network a configuration;
determining based on the configuration the need for an uplink transmission of information on a subset of carriers or cells; and
sending at least one uplink transmission towards a network node of the communication network comprising an indication identifying the information transmitted in the selected subset of carriers or cells.

18. An apparatus, comprising:
at least one processor; and
at least one non-transitory memory storing instructions, that when executed by the at least one processor, cause the apparatus at least to:
configure, by a network node of a communication network, a user equipment with a configuration for an uplink transmission on a plurality of carriers or cells,
determine a subset of carriers or cells for uplink reception within the plurality of carriers or cells that scheduled the user equipment for uplink transmission;
receive information for at least one uplink transmission by a user equipment,
wherein the information comprises uplink transmission resources for two or more component carriers or cells for the at least one uplink transmission; and
based on the information, identify the transmission for each component carrier where transmission resources where allocated.

19. The apparatus of claim 18, wherein the determination is based on at least one of a largest allocation, type of uplink allocation, a configured grant to the user equipment, based on a selected or preferred transmission, associated with a switching time, a maximum permitted power per configured uplink, or additional maximum power reduction of a band at the user equipment.

20. The apparatus of claim 18, wherein the information comprises decoding information for a component carrier for the at least one uplink transmission.

21. The apparatus of claim 20, wherein the configuration comprises a power splitting configuration based on physical uplink control channel or physical uplink shared channel information to be simultaneously transmitted on uplink component carriers.

22. The apparatus of claim 21, wherein the configuration comprises a set of rules for prioritizing uplink transmissions in case of collisions between a physical channels.

23. The apparatus of claim 22, wherein the prioritizing comprises prioritizing u-plane or c-plane data to be sent over the component carrier based on an available grant size and preconfigured rules.

24. The apparatus of claim 23, wherein u-plane refers to user-plane data that is data an end user is sending towards the targeted receiver comprising at least one of a server or other end user, and wherein c-plane refers to control plane data that terminates at a radio network or the end user equipment, wherein the control plane data comprises at least one of a medium access control header or a radio resource control message reference signal.

25. The apparatus of claim 18, wherein the information is based on uplink control information comprising an uplink control information header indicating data included in each uplink transmission of the at least one uplink transmission.

26. The apparatus of claim 24, wherein the header comprises an N-UCI field.

27. The apparatus of claim 25, wherein the N-UCI field comprises a preconfigured identifier and a length field.

28. The apparatus of claim 25, wherein the N-UCI field is a fixed sized field.

29. The apparatus of claim 25, wherein the N-UCI field is present with a physical uplink shared channel or a uplink control information on the physical uplink shared channel for checking prior to physical uplink shared channel decoding.

30. The apparatus of claim 25, wherein the N-UCI field is present as an extension to a MAC header when only data is transmitted over the at least one transmission.

31. The apparatus of claim 24, wherein the header is for determining uplink cells that transmitted data on different component carriers.

32. The apparatus of claim 18, wherein the identifying is using uplink-scheduling downlink control information sent to the user equipment and to a secondary network node of the communication network.

33. The apparatus of claim 16, wherein the identifying is using downlink-scheduling downlink control information sent to the user equipment and to a secondary network node of the communication network.

34. The apparatus of claim 32, wherein the at least one non-transitory memory is storing instructions executed by the at least one processor to cause the apparatus to:
dynamically share with the secondary network node at least one of:
a downlink control information grant or configured grant semi-persistent scheduling configuration, or
user power headroom or estimated transmission power of the user equipment.

35. The apparatus of claim 33, wherein the at least one non-transitory memory is storing instructions executed by the at least one processor to cause the apparatus to:
dynamically receive from the secondary network node a provided at least one of:
downlink control information grant or configured grant semi-persistent scheduling configuration, or
user power headroom or estimated transmission power of the user equipment.

36. The apparatus of claim 33, wherein the at least one non-transitory memory is storing instructions executed by the at least one processor to cause the apparatus to:
determine a probability of set of active uplinks; and
determine whether an active uplink of the set belongs to the secondary network node.

37. The apparatus of claim 35, wherein the at least one non-transitory memory is storing instructions executed by the at least one processor to cause the apparatus to:
based on there being an active uplink belonging to the secondary network node,
demodulate at least one of a physical uplink control channel or a physical uplink shared channel;
decode uplink control information from the secondary network node uplink front haul data.

38. The apparatus of claim 36, wherein the at least one non-transitory memory is storing instructions executed by the at least one processor to cause the apparatus to:
determine if the decoding was successful.

39. The apparatus of claim 38, wherein the at least one non-transitory memory is storing instructions executed by the at least one processor to cause the apparatus to:
based on no active uplink belonging to the secondary network node,
demodulate at least
one of a physical uplink control channel or a physical uplink shared channel;
decode uplink control information based on uplink front haul data based on shared uplink downlink control information or configured grant information.

40. The apparatus of claim 39, wherein the at least one non-transitory memory is storing instructions executed by the at least one processor to cause the apparatus to:
based on uplink control information indicating data for the secondary network node in
included in the at least one of a physical uplink control channel or a physical uplink shared channel, discard other distributed unit data.

41. A method, comprising:
configuring, by a network node of a communication network, a user equipment with a configuration for an uplink transmission on a plurality of carriers or cells,
determining a subset of carriers or cells for uplink reception within the plurality of carriers or cells that scheduled the user equipment for uplink transmission,
receiving information for at least one uplink transmission by a user equipment,
wherein the information comprises uplink transmission resources for two or more component carriers or cells for the at least one uplink transmission; and
based on the information, determining a subset of component carriers or cells on which the user equipment transmitted, and identify the transmission for each component carrier where transmission resources where allocated.
